(19) United States
(12) Patent Application Publication
(10) Pub. No.: US 2003/0153998 A1
(43) Pub. Date: Aug. 14, 2003

(54) Feature modeling application

(75) Inventor: Shane Clifford, Boise, ID (US)

Correspondence Address: SCHWEGMAN, LUNDBERG, WOESSNER & KLUTH, P.A., P.O. BOX 2938, MINNEAPOLIS, MN, 55402, US

(73) Assignee: Micron Technology, Inc.

(21) Appl. No.: 10/075,181

(22) Filed: Feb. 13, 2002

(51) Int. Cl. G06F 19/00; H02H 3/05

(52) U.S. Cl. 700/121; 714/51

(57) ABSTRACT

Methods and systems for generating computer-executable code are provided. Feature diagrams are utilized to help produce deterministic statecharts. Design choices and changes are accomplished by entering modifications to feature diagrams. The feature diagrams are associated with statecharts and as the feature diagrams are modified corresponding changes are made to the associated statecharts, producing deterministic statecharts. Once all the chosen modifications to the feature diagram(s) have been performed, the resulting, newly-created statechart(s) will be deterministic and can be advantageously utilized to generate computer-executable code. Computer-executable code can be generated that is useful for implemented real-time control systems, including real-time systems for controlling semiconductor equipment.

### FIELD OF THE INVENTION

The present invention relates to the utilization of feature models to aid in the production of deterministic statecharts. The deterministic statecharts produced according to the present invention can be advantageously utilized in generating computer-executable code.

### BACKGROUND OF THE INVENTION

The development of complex real-time systems presents a difficult challenge for software engineers. Much work has been done on “horizontal” domain frameworks to support many of the requirements of real-time systems. These frameworks, such as the Adaptive Communications Environment (ACE), are valuable for meeting the demands of many different kinds of real-time systems. However, very little work has been done to provide implementation support for “vertical” domain reuse of real-time components. As presented in OMG Unified Modeling Language (“UML”) Specification, Version 1.3 (available at http://www.omg.org/cgi-bin/doc?ad/99-06-08 and hereby incorporated by reference), horizontal domains encompass only one system part, for example, GUIs, database systems, middleware, matrix computation libraries, container libraries, frameworks of financial objects, and so on. Vertical domains, on the other hand, cover complete systems, for example, flight reservation systems, medical information systems, CAD systems, and so on.

Frequently, designers of reusable real-time system families are plagued with the dilemma of having to choose between the desire to reuse general behavior across multiple systems and the desire for flexibility in each individual system to meet stakeholder demands. This dilemma is further complicated by the desire to modify (for example, update) the general or generic behavior across multiple existing systems without adversely impacting the specialized behavior designed into any existing individual systems. The value of generalization is severely reduced if it is only available at the inception or initial design of an individual system or if it requires large-scale rework of a system to introduce system modifications to the general behavior.

One existing approach to solving this dilemma can be found in AutoShell (available from Texas Instruments). The AutoShell approach endeavors to solve the dilemma by providing sufficient horizontal domain flexibility to a developer so as to render the need for vertical domain reuse moot. A problem with this approach is that it ignores the need to modify general behavior across multiple systems with reduced impact on the specialized behavior of individual systems. The result of this approach is that new systems can be produced rapidly, but any new feature that needs to be introduced across an entire family or class of systems must be carefully inserted into each existing system individually. As the number of systems in a family grows, this task of introducing modifications, such as new features, can become time-consuming and expensive, especially as knowledge of how the individual systems were developed is dispersed.

Another concern with developing reusable components for real-time systems is related to the introduction of additional complexity. Given that existing complex real-time systems can be extremely difficult to work with, determining how to correctly reuse components can be seen as a significant burden to application developers. This has been the case with the production system based approach. Frequently, the underlying system architecture is short-circuited or designed around, which then limits the ability to later modify general behavior across an entire family or class of systems.

Accordingly, there still exists a need for technology that allows developers of real-time systems to more easily design families or classes of systems and more easily modify the general behavior of systems across existing families or classes of systems.

### SUMMARY OF THE INVENTION

The present invention addresses the issues presented above by providing development tools for developers of computer-executable code. One particularly advantageous use of the present invention is in the production of real-time systems, especially those real-time systems useful for controlling equipment used in the semiconductor industry.

Feature diagrams are utilized to help produce deterministic statecharts. Design choices and changes are accomplished by entering modifications to feature diagrams. The feature diagrams are associated with statecharts and as the feature diagrams are modified corresponding changes are made to the associated statecharts, producing deterministic statecharts. Once all the chosen modifications to the feature diagram(s) have been performed, the resulting, newly-created statechart(s) will be deterministic and can be advantageously utilized to generate computer-executable code.

### DESCRIPTION OF THE DRAWINGS

The present invention is illustrated by way of example in the following drawings in which like references indicate similar elements. The following drawings disclose various embodiments of the present invention for purposes of illustration only and are not intended to limit the scope of the invention.

FIG. 1 illustrates a generic feature diagram generated in accordance with the teachings of the present invention.

FIG. 2 illustrates another generic feature diagram generated in accordance with the teachings of the present invention.

FIG. 3 illustrates a potential statechart in accordance with the teachings of the present invention that corresponds to the feature diagram of FIG. 2.

FIG. 4 illustrates a feature diagram generated from the feature diagram of FIG. 2 in accordance with the present invention.

FIG. 5 illustrates a deterministic statechart generated from the potential statechart of FIG. 3 in accordance with the present invention.

FIG. 6 illustrates a feature diagram in accordance with the present invention that represents a Lot of semiconductor wafers.

FIG. 7 illustrates a potential statechart in accordance with the present invention that corresponds to the feature diagram of FIG. 6

FIG. 8 illustrates a feature diagram generated from the feature diagram of FIG. 6 in accordance with the present invention.

FIG. 9 illustrates a deterministic statechart generated from the potential statechart of FIG. 7 in accordance with the present invention.

FIG. 10 illustrates an example of a system according to the present invention.

FIG. 11 illustrates an example of a statechart for a system to be executed by a semiconductor equipment controller.

FIG. 12 illustrates a feature diagram for the statechart of FIG. 11.

FIG. 13 illustrates a sub-feature diagram for a feature of FIG. 12.

FIG. 14 illustrates a statechart for the sub-feature diagram of FIG. 13.

FIG. 15 illustrates a workflow diagram for a Feature Developer utilizing the present invention.

FIG. 16 illustrates a workflow diagram for an Integration Developer utilizing the present invention.

### DETAILED DESCRIPTION OF THE INVENTION

In the following detailed description of the present invention, reference is made to the accompanying Drawings, which form a part hereof, and in which are shown by way of illustration specific embodiments in which the present invention may be practiced. It should be understood that other embodiments may be utilized and structural changes may be made without departing from the scope of the present invention.

The present invention utilizes the concept of feature modeling: the activity of modeling the common and variable properties of concepts and their interdependencies and organizing them into a coherent model. An explanation of feature modeling and its application in the present invention is provided herein. However, more information about feature modeling in general can be found in the literature, such as Chapter 4 of Generative Programming by K. Zarnecki and U. W. Eisenecker (Addison-Wesley, Reading, Mass. May 2000), herein incorporated by reference.

A feature model represents a concept and how the concept is intended to be used by the concept's designer. A feature model consists of a feature diagram and additional information, such as semantic descriptions of each feature, rationales for each feature, examples of systems using each feature, and constraints. From a feature diagram of a concept, featural descriptions of the individual instances of the concept can be derived.

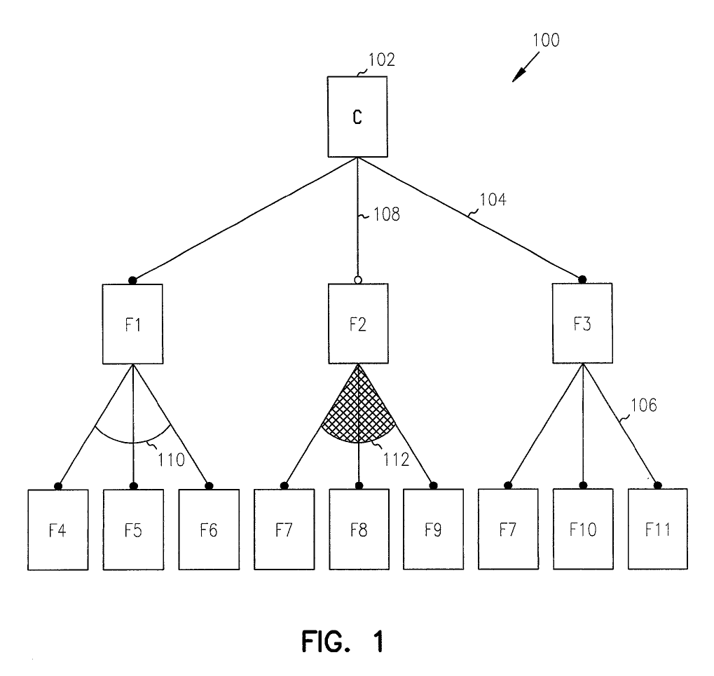

FIG. 1 depicts an example of a feature diagram 100. The root of a feature diagram is a concept. The root is represented in FIG. 1 by concept C 102. The edges of a feature diagram connect to features of the concept, sub-features of those features, and so on. In FIG. 1, two examples of edges are indicated as edge 104 and edge 106. A filled circle at the end of an edge indicates that feature is required. For example, edge 104 in FIG. 1 indicates that feature F3 is a required feature of concept C and edge 106 in FIG. 1 indicates that sub-feature F11 is a required sub-feature of feature F3. An open circle at the end of an edge indicates a feature is optional. For example, edge 108 in FIG. 1 indicates that feature F2 is an optional feature of concept C. An open arc connecting two or more edges indicates those features or sub-features are alternatives (that is, those features are mutually exclusive features). For example, arc 110 in FIG. 1 indicates that sub-features F4, F5, and F6 are alternate sub-features of feature F1. A filled arc connecting two or more edges indicates those features or sub-features are or-features. An or-feature is a feature or sub-feature belonging to a group of features or sub-features from which at least one feature or sub-feature must be included in the parent feature or concept. Including more than one feature or sub-feature in the parent feature or concept is acceptable. For example, filled arc 112 in FIG. 1 indicates that sub-features F7, F8, and F9 are or-features. That is, one or more of the sub-features F7, F8, and F9 must be included in parent feature F2. It should also be understood that a feature or sub-feature could appear in more than one location in a feature diagram. For example, sub-feature F7 in FIG. 1 is both an or-feature of feature F2 and a required feature of feature F3.

According to the present invention, feature diagrams are utilized to help address the previously described dilemma facing developers of systems, especially real-time systems. The active objects that together define a domain of interest in a system family are represented as concepts in a feature model. These concepts (such as equipment, lot, wafer, die, etc. in a semiconductor manufacturing environment) are a collection which have associated features and which represent the system family. These concepts are then described in feature diagrams. Specifically, the present invention uses feature diagrams to model the states of concepts, the attributes of concepts, and the relationships of concepts to other concepts. These states, attributes, and relationships are represented in feature diagrams as simple features using common semantics. However, the features are associated with types to designate the features as states, attributes, or relationships. That is, a feature in a feature diagram can be designated as a state, an attribute, or as a relationship. The typing of features provides an association to other representations, namely state diagrams and class diagrams, of the system or systems being developed.

The use of feature diagrams in accordance with the present invention allows concepts to be conveyed to a system developer as very simple hierarchies of features. When a system developer chooses to include a concept in a system, the developer can immediately see what features are provided by that concept. Developers can choose between any alternative features to best meet the requirement of their customer as well as include any optional features a customer may request. In fact, the use of feature diagrams according to the present invention allows a system developer to work directly with the customer in selecting appropriate features from the feature diagrams. The features as presented to the customer are not described using class hierarchies or state machine semantics, which can be difficult to understand even for many developers. Instead, the features are described by simple statements of their rationale and value to the customer. When a developer and/or customer selects a concept to be included in a system design, the pre-selected required features of that concept are also automatically included. Also, the developer and/or customer need only select features and sub-features to a level of detail they feel is adequate for the particular application. Default feature and sub-feature selections defined by the feature diagram developer(s) can be accepted. Additionally, a feature diagram developer upon request can implement new features.

The present invention utilizes feature diagrams in conjunction with statecharts (also, referred to as statechart diagrams or state diagrams). A statechart is used to describe the behavior of a computer-implemented object (that is, concept) in sequences of states and actions through which the object can proceed during its lifetime as a result of reacting to events. That is, a statechart diagram is a diagram that shows a state machine. A state machine is a specification of a sequence of states that an object or an interaction goes through during its lifetime, in response to events, and also the responses that the given object or interaction makes to those events. In a preferred embodiment of the present invention, the statecharts utilized are consistent with statecharts as defined by the Unified Modeling Language (“UML”) as described in Unified Modeling Language Specification, Version 1.3 (OMG, June 1999), herein incorporated by reference. The statecharts generated according to the present invention are then used to generate the computer-executable code that implements the designed system.

When a developer makes design choices on a feature diagram, corresponding changes are made to the statechart(s) that describe the behavior of the computer-executable system to be implemented. It is not required that the changes to the corresponding statechart(s) be automated. However, automating some or all of these changes reduces the time and cost of developing the final system. In a preferred embodiment, the present invention comprises a feature diagram editor that automatically makes some of the needed changes to a corresponding statechart. Alternately, a developer can make changes to statecharts manually.

Feature diagrams are modified in the following manner. In the first step, a feature that is a state-type is added to a feature diagram. This causes a new state to be placed on the corresponding statechart. In a preferred embodiment, a feature diagram editor places the new state on the corresponding statechart automatically. This is repeated as necessary to meet the needs of the concept being modeled. If the added state-typed feature is an optional feature, a decision state that has a guarded transition to the new state and an else transition is added to the statechart. The else transition can be directed manually to wherever the developer chooses. A guarded transition is a transition that has an associated Boolean condition (that is, a guard-condition). The Boolean condition must be true for that transition to be followed to the next state.

In a second, optional step relationships are created between features on the feature diagram. These relationships can include alternate (that is, open-arc) relationships and or-feature (that is, closed-arc) relationships as described above. When an alternate relationship is created between two or more features on the feature diagram, the editor creates a single decision state on the statechart that. has one guarded transition from the single decision state to each of the states in the alternate relationship. If the alternates are also optional, there is also an else transition created from the single decision state that the developer can direct manually. When an or-feature relationship is created between two or more features on the feature diagram, the editor creates a separate decision state on the statechart for each of the states in the or relationship. Each of the separate decision states has a transition to a corresponding state in the or relationship. Each of the separate decision states also has an else transition that can be directed by the developer.

In a third step, a developer may add any other “meaningful” transitions to a statechart. A meaningful transition is a transition that is caused to happen or triggered by some signal or stimulus. Meaningful transitions are generally added manually to the statechart by a feature developer. An editor may redirect these meaningful transitions automatically, but they are not generally added or removed automatically. If a state is preceded in the statechart by one of the generated decision states, then the developer can only direct transitions to the decision state, not directly to the state that the decision state precedes.

According to the present invention, all of the guard-conditions generated in accordance with feature diagram modifications are dependent on the existence of the state to which the guarded transition is directed. This is an important aspect of statecharts according to the present invention. Statecharts containing guarded transitions are not deterministic. Statecharts that are not deterministic are referred to herein as potential statecharts.

The present invention utilizes the manipulation of feature diagrams to drive the manipulation of potential statecharts to produce deterministic statecharts. Deterministic statecharts help in the generation of computer-executable code because all possible run-time execution paths are known at compile time. Having a desired system described in terms of deterministic statecharts allows the building of a static representation of the state machine for each object at compile time, ensuring greater speed and reliability of the final system at run-time.

During development of a desired system, a system developer chooses the concepts that are to be included in the desired system. As explained above, these concepts are represented by feature diagrams, which make it easy for the system developer to choose what concepts are needed. The feature diagrams, as also explained above, are associated with corresponding potential statecharts. A system developer manipulates the chosen feature diagrams to generate deterministic statecharts by selecting features in the feature diagram for inclusion in a version of the desired system. All required features are automatically included so they require no action. Optional features are either selected or not selected. One and only one member of each alternate feature relationship is selected for inclusion, unless the features are also optional, in which case there may be no selection. One or more members of each or-feature relationship are selected for inclusion. When all selections are made to the feature diagram, the corresponding statechart will have no remaining guarded transitions and will be deterministic.

In a preferred embodiment, a feature diagram editor automatically modifies the potential statechart in the following manner. Of course, a system developer could make these modifications directly, but it is faster and less prone to error to have the feature diagram editor program make the modifications automatically. Each time a choice is made for an alternate relationship in a feature diagram, the corresponding decision state is removed. All transitions that had been directed to the removed decision state are redirected to the state selected from among the alternatives. If the alternatives are optional and no selection is made, the transitions that were directed to the decision state are directed to wherever the developer directed the else transition during the creation of the alternate relationship. The creation of alternate relationships occurs in the optional second step previously discussed.

All states that were not selected are also removed from the statechart. For each optional state, and for each state in an or-feature relationship, the preceding decision state is removed. If an optional state or a state in an or-feature is selected, all transitions in the statechart that had been directed to the decision state are redirected to the selected state, thereby modifying the statechart to create a new statechart. If the state is not included, all transitions that were directed to the decision state are directed to wherever the developer directed the else transition. The state that was not selected is also removed.

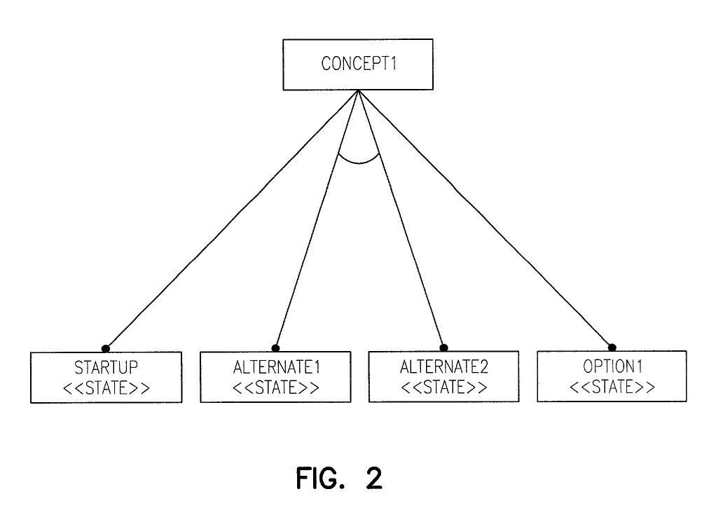

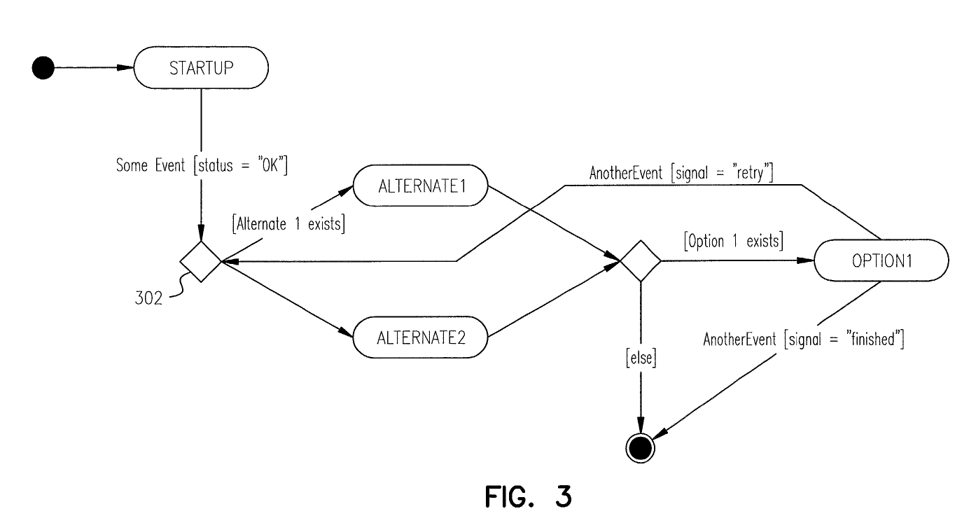

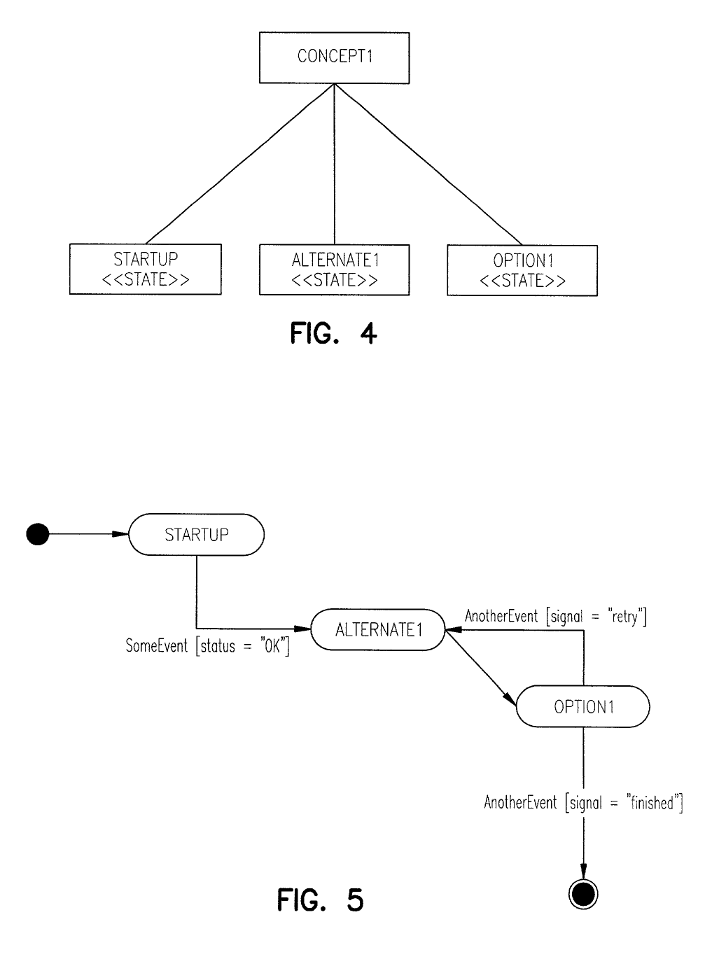

As a system developer modifies a feature diagram, thereby choosing or ruling out various alternate and optional features as described above, more and more of the potentiality of the corresponding statechart is removed. In this manner, the existing statechart is modified, creating a new statechart. Once all necessary feature choices have been made using the feature diagram(s), the corresponding potential statechart(s) will be transformed into a fully deterministic statechart. In this manner, modifications, updates, and revisions of systems can be implemented in a more seamless and efficient “vertical” fashion across a family of systems. This process is illustrated in FIGS. 2-5. FIG. 2 illustrates an example of a generic feature diagram having no selections made. FIG. 3 illustrates the potential statechart corresponding to the feature diagram of FIG. 2. For example, FIG. 3 shows the meaningful transition marked “SomeEvent [status=‘OK’]” being directed to decision state 302. FIG. 4 illustrates the feature diagram resulting from making design choices or selections on the feature diagram illustrated in FIG. 2. FIG. 5 illustrates the deterministic statechart generated when modifications to the potential statechart of FIG. 3 are completed in accordance with the selections made to the feature diagram of FIG. 2 to produce the feature diagram of FIG. 4. For example, in FIG. 5 the meaningful transition marked as “SomeEvent [status=‘OK’]” in FIG. 3 has been removed and redirected to Alternatel because the decision state has been removed by the selection process (that is, selecting Alternatel) performed on the feature diagram by the system developer.

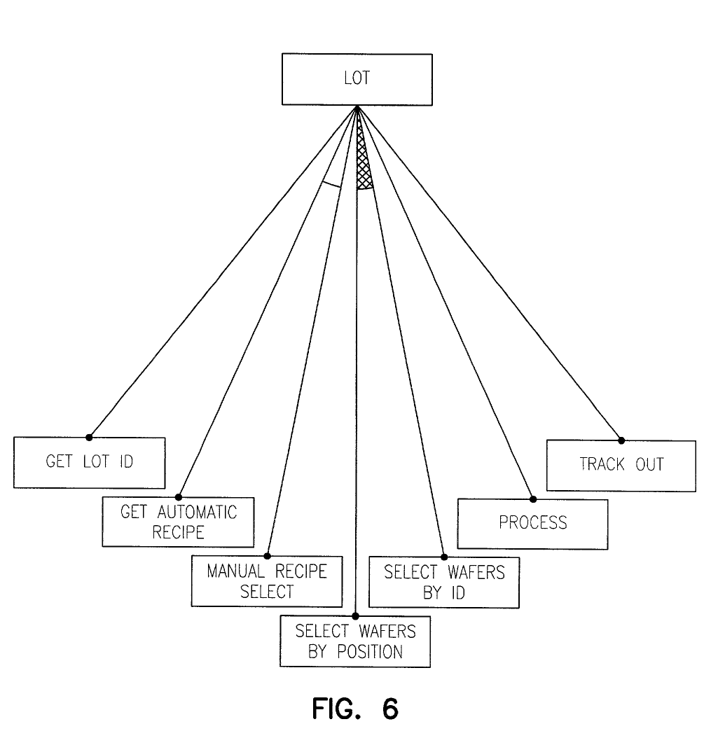

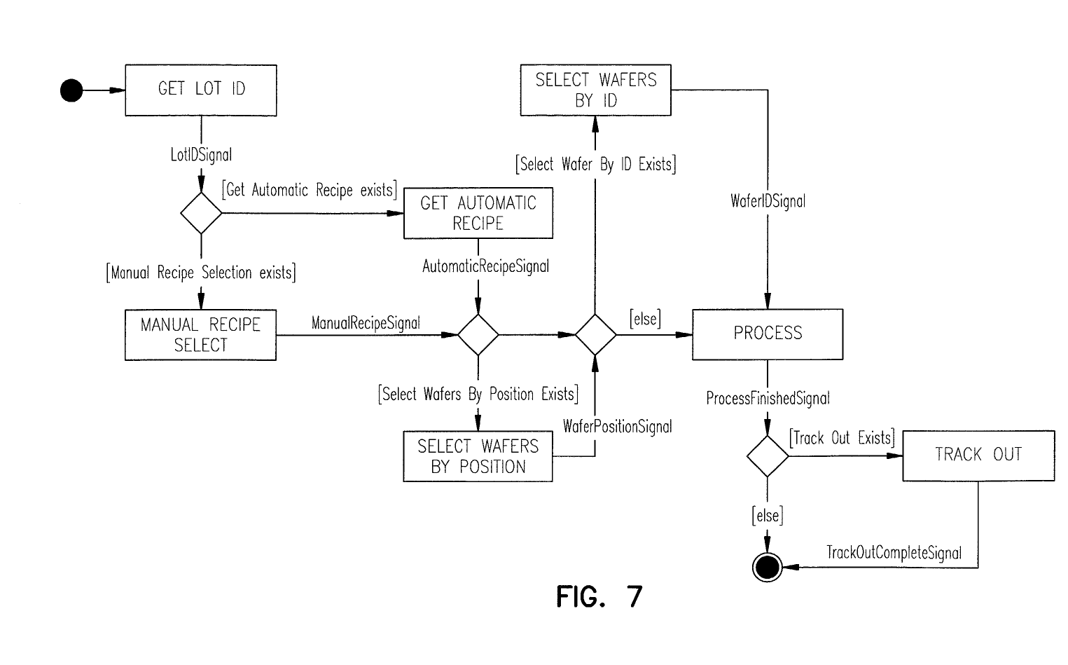

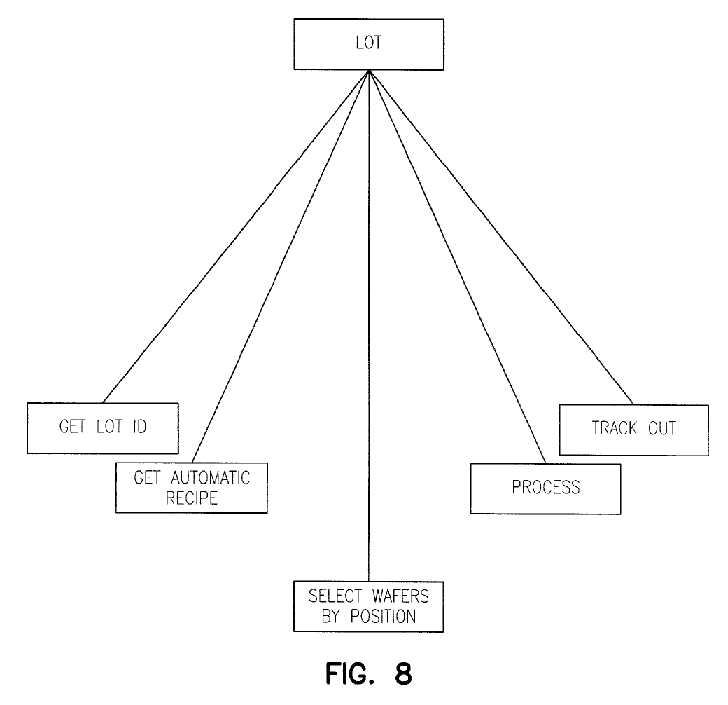

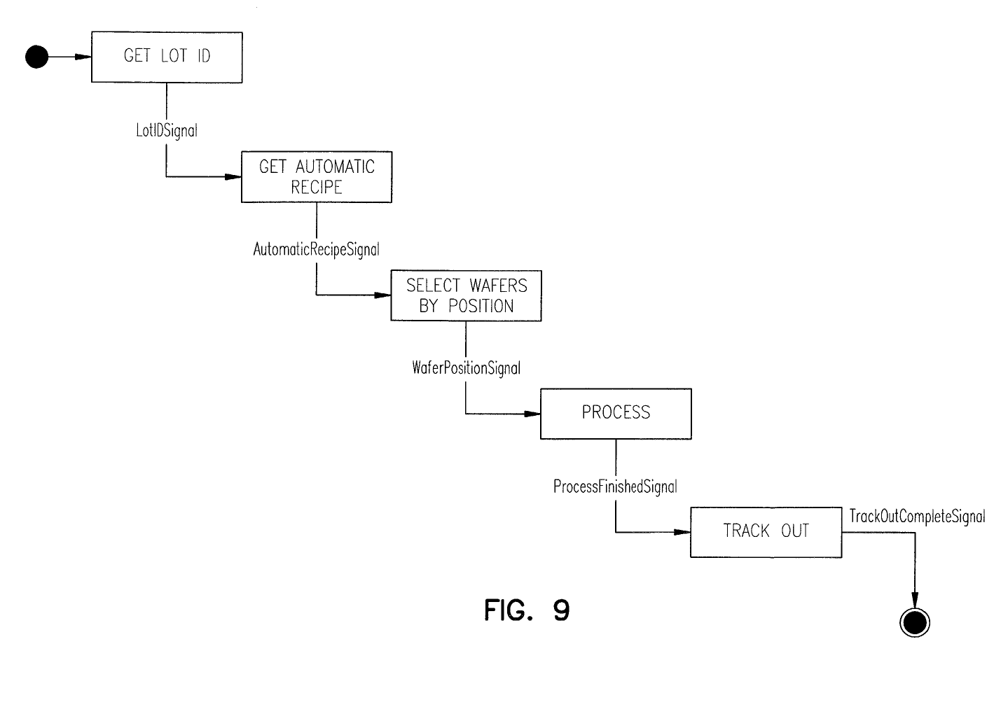

FIGS. 6-9 further illustrate the present invention's process of modifying statecharts in conjunction with design choice modifications of feature diagrams. FIGS. 6-9 are based on an example of an embodiment of the present invention used to generate a real-time control system that controls the semiconductor equipment used to process a Lot of semiconductor wafers. FIG. 6 illustrates a feature diagram representing a Lot of semiconductor wafers. FIG. 7 illustrates the initial potential statechart created in conjunction with the creation of the feature diagram in FIG. 6. FIG. 8 illustrates the resulting feature diagram after all the selections to the feature diagram of FIG. 6 have been made according to the teachings of the present invention. FIG. 9 illustrates the deterministic statechart generated when modifications to the potential statechart of FIG. 7 are completed in accordance with the selections made to the feature diagram of FIG. 6 to produce the feature diagram of FIG. 8. The deterministic statechart of FIG. 9 is used to help generate the computer-executable code that implements the real-time control system for controlling the semiconductor equipment that processes the Lot of semiconductor wafers.

In another embodiment the present invention is a system useful for generating computer-executable code. Systems of the present invention can be advantageously utilized to produce real-time control systems, especially those real-time control systems useful for controlling equipment used in the semiconductor industry.

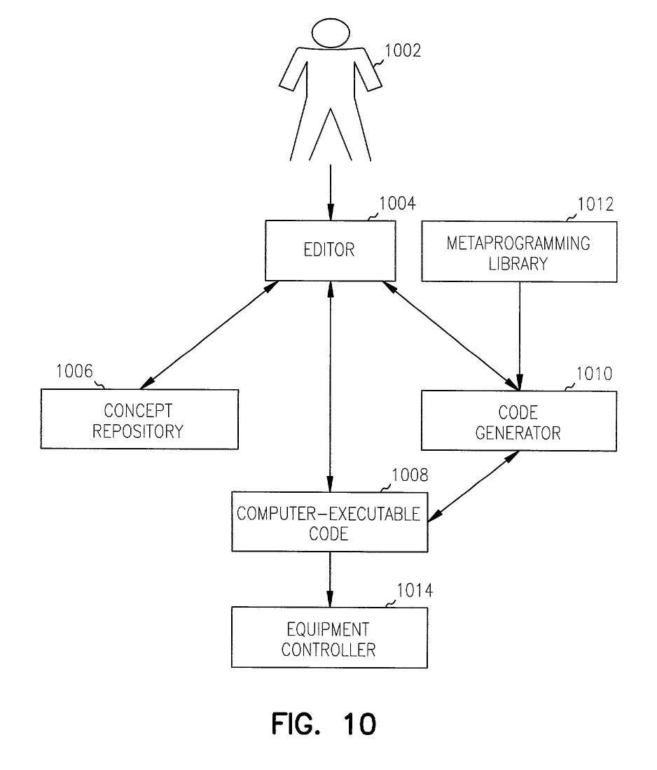

FIG. 10 illustrates an example of an embodiment according to the present invention. A developer 1002 interacts with a system Editor 1004. A developer that interacts with the system Editor 1004 to create new feature diagrams or to modify existing feature diagrams is frequently referred to as a Feature Developer. A developer that interacts with the system Editor 1004 to create statecharts, to modify existing statecharts, or to develop an executable system is frequently referred to as an Integration Developer or a System Developer. The Feature Developer and the Integration Developer may be separate individuals interacting with the system Editor 1004 at different times or separate individuals interacting with the system Editor 1004 at the same time. Alternately, the role of Feature Developer and the role of Integration Developer may be performed by a single individual. Thus, the terms Feature Developer and Integration Developer are not intended to be limiting, but are used to help describe different ways in which users of the present invention (for example, developers) may interact with systems according to the present invention.

A Feature Developer can utilize the system Editor 1004 to create new concepts. Each concept has its own feature model diagram and associated potential statechart diagram. Once created, the concept, along with its feature model diagram and associated potential statechart diagram are stored in a Concept Repository 1006. Feature Developers can retrieve concepts from the Concept Repository 1006 and use them in the future to help create new concepts by altering the feature diagrams and associated potential statecharts. When a Feature Developer retrieves a concept in the Concept Repository 1006 for the purpose of modifying the concept, write access to the concept is locked. Locking write access to a concept prevents a second Feature Developer from trying to modify the same concept at the same time. The process of retrieving a concept and locking write access to it is frequently referred to as Checking Out the concept. When a Feature Developer is finished creating or modifying a concept, the concept is returned to the Concept Repository 1006 and is unlocked. The process of returning a concept and unlocking write access to it is frequently referred to as Checking In the concept. When a concept is Checked In, all other developers working with the same system family can be immediately notified of the new version. In this manner, developers can leverage the useful work of previous developers and the Concept Repository 1006 performs as a version control system. Developers can reuse entire previous system designs or individual concepts used in a previous system design. The Concept Repository 1006 can be used to store system designs where each design may be application specific.

In developing a new system, the Integration Developer interviews stakeholders to determine the required features for the needed system. Stakeholders include individuals with knowledge or expertise in a variety of disciplines, including operations process engineering, equipment engineering, etc. The Integration Developer provides a list of automatically supplied features, optional features, and presents alternate solutions for some features. An Integration Developer may also evaluate equipment capabilities and requirements by obtaining vendor documentation and testing the equipment. Additionally, the Integration Developer can work with a Feature Developer to discuss implementation of any new concepts or features that may be needed.

When utilizing the present invention to design a new system, an Integration Developer will typically first choose an existing system family from which to develop a new instance of a specific system. Alternatively, the Integration Developer can start with an existing system and modify it to meet the needs of the new system to be developed. The Integration Developer typically starts development by choosing one or more concepts to be included into the new system. The chosen concepts may have dependencies, which in turn require inclusion of other concepts. The Integration Developer then chooses which optional features of the various included concepts are needed to develop the new specific system. The chosen optional features may have dependencies, which in turn require inclusion of other concepts or features. The Integration Developer chooses among the possible alternate features. Again, the chosen features may have dependencies, which in turn require inclusion of other concepts or features.

Once the Integration Developer has finished making all the necessary design choices, the Integration Developer can then use the present invention to generate an executable instance of the designed system. The Code Generator 1010 is the system component that utilizes the feature diagrams and deterministic statecharts to produce the Computer-Executable Code 1008 that implements the designed system when the Code 1008 is executed by an Equipment Controller 1014, for example. The Code Generator 1010 can interface with a Metaprogramming Library 1012 that stores computer-executable code. The computer-executable code in the Metaprogramming Library 1012 is generally developed once and can be used by the Code Generator 1010 in many different applications. Generally, the system Editor 1004 also interfaces with a Code Generator 1010. In this manner, an Integration Developer could utilize the system Editor 1004 to make custom modifications or optimizations directly to the generated Computer-Executable Code 1008.

After the designed system has been generated in accordance with the present invention, the resulting executable code can be deployed or installed on the hardware platform that will execute the code. In one preferred embodiment, the hardware platform comprises semiconductor equipment controller hardware. After system deployment, the hardware platform executes the code that implements the designed system. In one preferred embodiment, a semiconductor equipment controller executes a system that has been generated and deployed in accordance with the present invention. The semiconductor equipment controller advantageously aids in automating a semiconductor manufacturing environment.

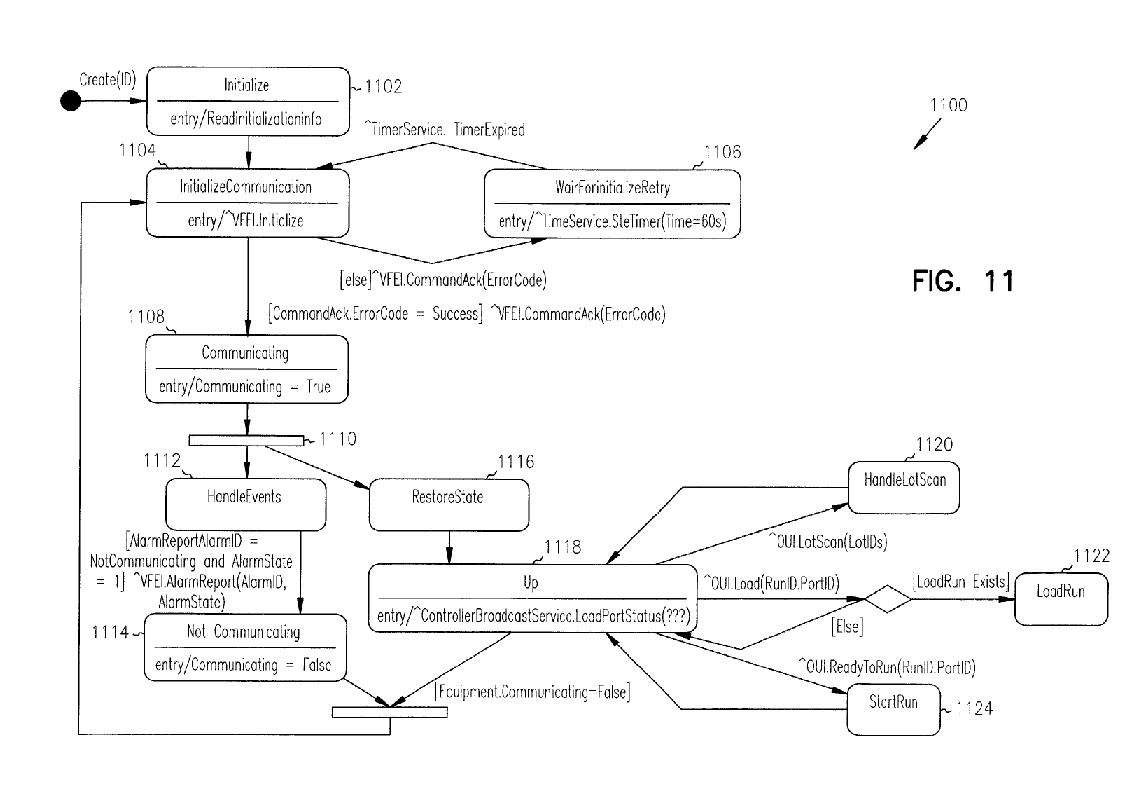

An example of a statechart for a system to be executed by a semiconductor equipment controller is shown in FIG. 11. The statechart 1100 in FIG. 11 can be thought of as a high-level view of the behavior required to integrate equipment into an automated control system for a semiconductor manufacturing application. When the system represented by the statechart 1100 is executing, certain processes may be performed at each state. During the Initialize state 1102, the system reads a configuration file to load information about the specific instance of equipment being controlled. Transition out of the Initialize state 1102, occurs immediately following successful processing of the configuration file. During the InitializeCommunication state 1104, the system sends a message to the controlled equipment to start communicating. The InitializeCommunication state 1104 has two out-going transitions. The first out-going transition, “[CommandAck.ErrorCode=Success] \hat{ }VFEI.CommandAck(ErrorCode),” is guarded to only be taken if communication is successfully initialized. The other out-going transition, “[else]\hat{ }VFEI.CommandAck(ErrorCode)”, is taken whenever the first out-going transition is not taken. The WaitForInitializeRetry state 1106 waits for one minute following a failure to initialize communication. After one minute has elapsed, the transition “\hat{ }TimerService. TimerExpired” is taken back to the InitializeCommunication state 1104. During the Communicating state 1108, the rest of the system is notified that successful communications has been achieved and a system Communicating attribute or variable is set to true. Splitter bar 1110 represents the fact that two concurrent transitions are taken. The first transition goes to the HandleEvents state 1112 and the second transition goes to the RestoreState state 1116. The HandleEvents state 1112 is responsible for responding to events that occur on the equipment once it is communicating. Examples of such events include Processing Start, Processing Complete, Processing Aborted, etc. The HandleEvents state 1112 is not transitioned out of until communication with the equipment fails or the system has been shutdown. During the Not Communicating state 1114, the rest of the system is notified that communication with the equipment has ended or has been lost.

The concurrent process RestoreState state 1116 is used to retrieve current run information from the semiconductor equipment that is being controlled by this statechart. Information about this equipment is sent to a central location called a Manufacturing Execution System (MES) which monitors overall plant control. Information as to what equipment is down (not functioning) or which Lot is at which location is sent to the MES from this equipment. Information about this equipment is periodically synchronized with the MES to ensure that both locations have the same information. Information discrepancies may occur due to lost communication or communication errors so the RestoreState state has to look for those discrepancies and handle them. Typically this would involve updating the MES to reflect what actually exists on the physical equipment.

During the Up state 1118, the system waits for events that arrive from a user of the system. Most of the transitions out of the Up state 1118 represent requests by a user for the controller to perform particular activities. The only exception is the transition guarded [Equipment. Communicating=False], which transitions back to a synchronization state that attempts to regain communication with the equipment again. The HandleLotScan state 1120, is entered when a user has requested setup of processing for another semiconductor lot or batch of lots. The LoadRun state 1122 is entered when a user has requested that a lot or batch of lots be loaded on the equipment. The transition into the LoadRun state 1122 is guarded with [LoadRun Exists]. Thus, the LoadRun state 1122 is an optional feature that may not be included in all instances of a semiconductor controller system represented by statechart 1100. The StartRun state would instruct the semiconductor equipment controller to start to process a new Lot of semiconductor wafers.

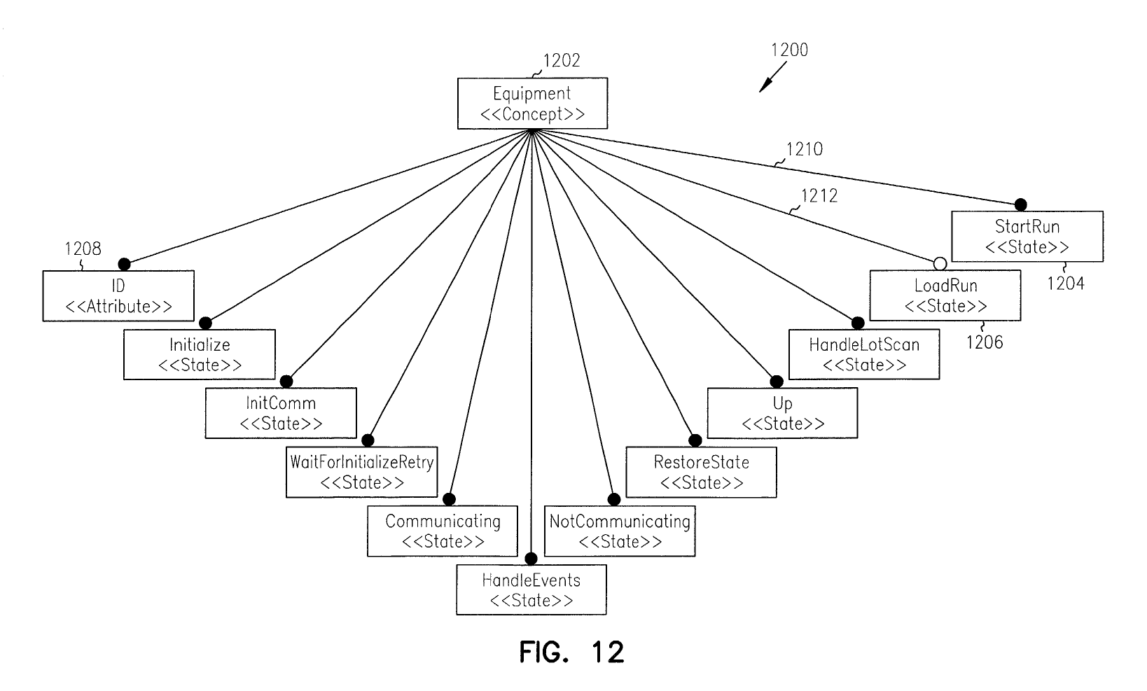

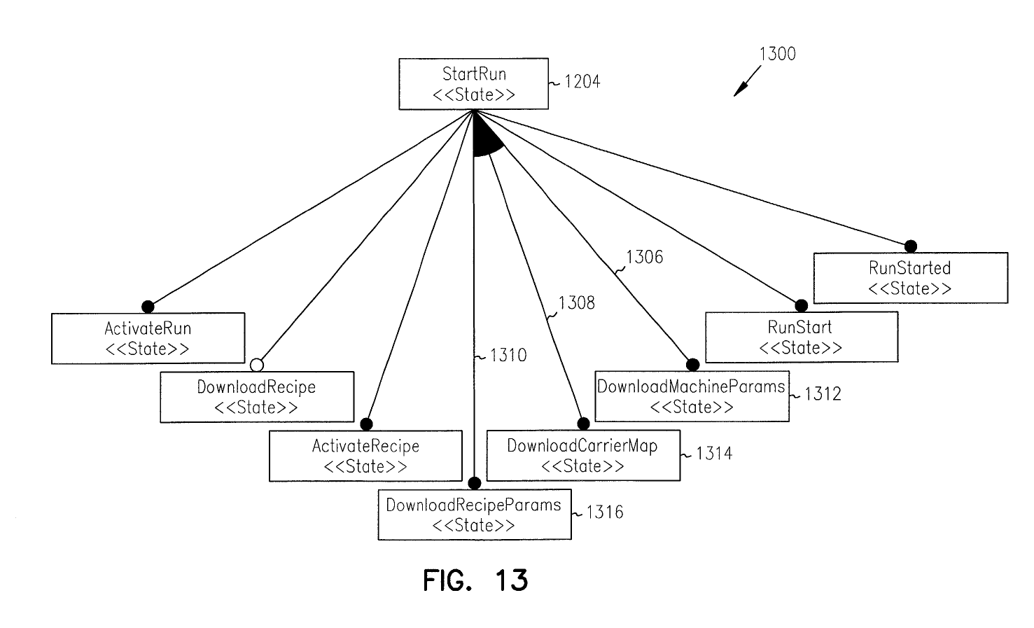

FIG. 12 depicts an a feature diagram 1200 for the statechart of FIG. 11. The root 1202 of the feature diagram is a concept which in this case is the semiconductor processing equipment to be controlled in real time. The edges of the feature diagram connect to features of the concept, sub-features of those features, and so on. In FIG. 12, examples of features are indicated as feature 1204 (a required state), feature 1206 (an optional state) and feature 1208 (an attribute). The filled circle at the end of edge 1210 indicates that feature is required. For example, edge 1210 in FIG. 12 indicates that feature StartRun is a required feature of the concept 1202. The open circle at the end of edge 1212 in FIG. 12 indicates that feature LoadRun is an optional feature.

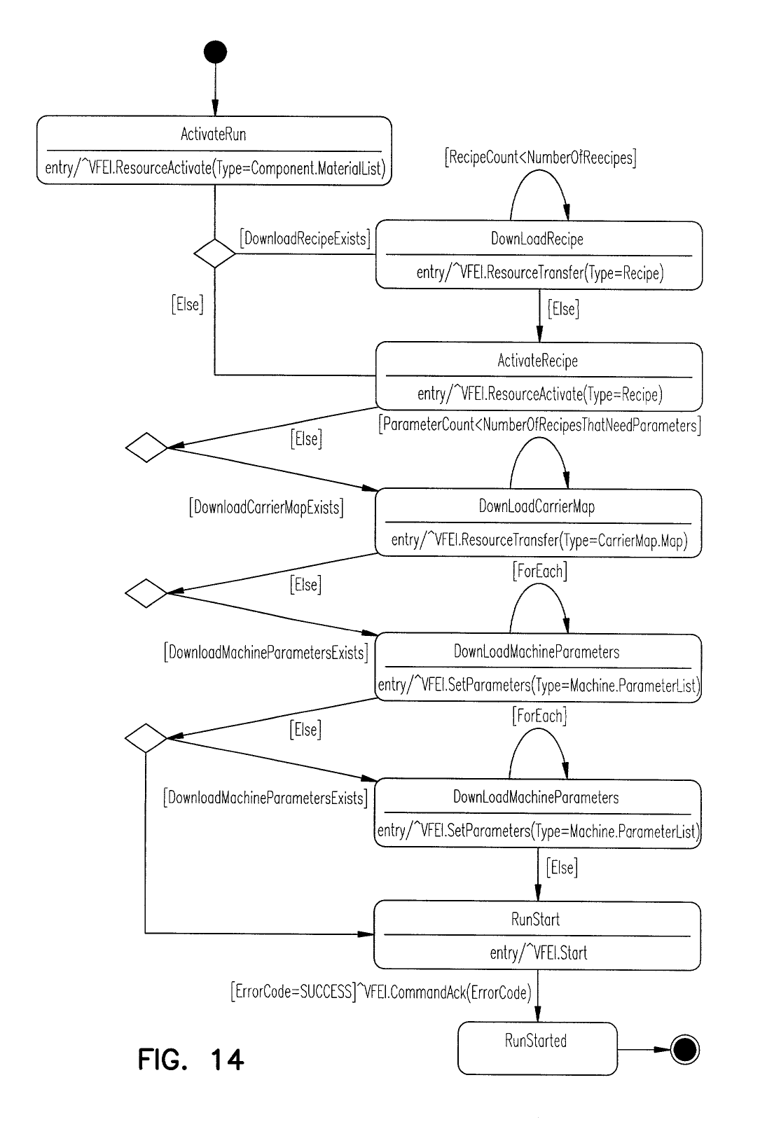

Features can have sub-features and the StartRun feature 1204 of FIG. 12 is shown in more detail in FIG. 13. In this feature diagram 1300, the filled arc connecting the three edges 1306, 1308 and 1310, indicates those sub-features are or-features. This means at least one of the sub-features 1312, 1314 or 1316 must be included in the parent feature1204. The resulting statechart for sub-feature diagram 1300 of FIG. 13 is shown in FIG. 14. This statechart 1400 reflects the features to be included into a process for controlling the semiconductor processing equipment after choices of features were selected from the feature diagrams.

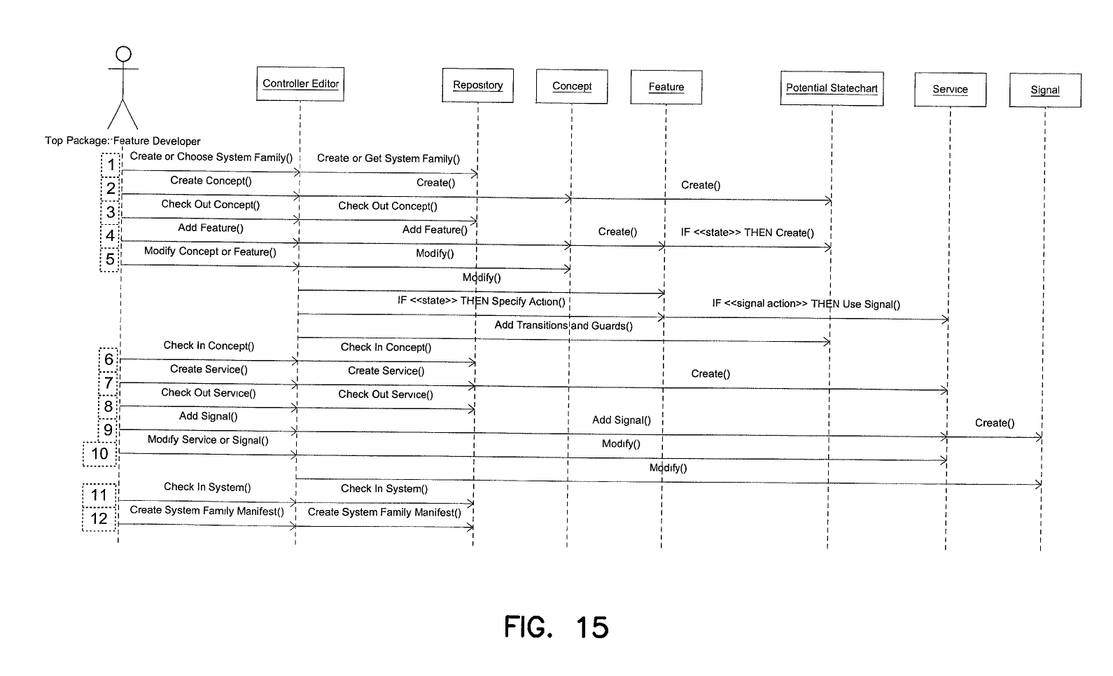

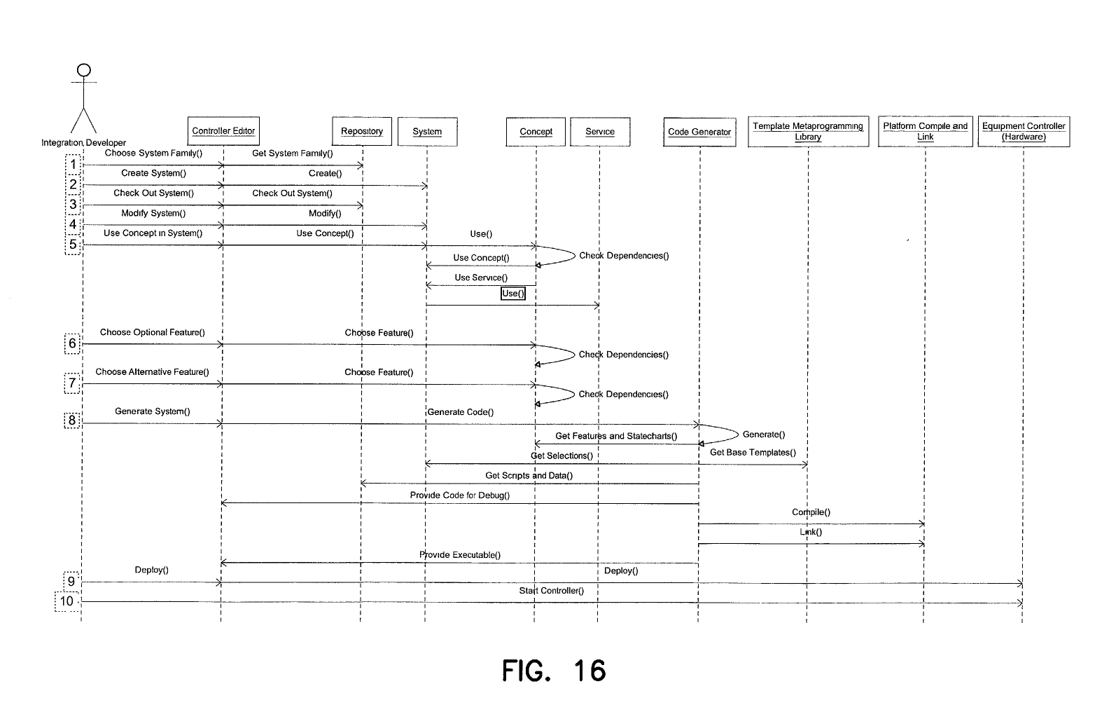

FIG. 15 is a workflow diagram showing how a Feature Developer would use the present invention to produce features for the concept repository. In this example, an equipment automation developer is producing features to control semiconductor processing equipment. A Feature Developer modifies the definition of a system family. This includes adding, removing and modifying concepts, adding, removing and modifying features and modifying potential statecharts. FIG. 15 describes the sequence of work steps from the Feature Developer s perspective. The steps are outlined below.

Step 1. Create or Choose System Family: The developer creates a system family or chooses a system family that already exists for making modifications. This causes the controller editor to communicate with the global repository to retrieve or create the desired system family.

A system is an executable instance of a system family created by the integration developer. A system family is a group of systems that can be defined within the context of a common set of concepts. Making feature selection decisions on concepts to arrive at a concrete system creates individual members of the system family (systems).

Step 2. Create Concept: The developer creates a new concept in the selected system family. The concept has its own feature model diagram and potential statechart diagram. It is also added to the potential class diagram for the system family.

A feature model is a coherently organized model of the common and variable properties of concepts and their interdependencies within a system family. The feature model is used to select optional and alternative features for inclusion in a concrete implementation of a concept in a system that is part of the system family.

A statechart diagram is a diagram used to describe the behavior of an object (concept) in sequences of states and actions through which the object can proceed during its lifetime as a result of reacting to discrete events. It represents the actual behavior of a concept following selection of features from a feature model. The potential statechart diagram is a diagram used to describe the potential behavior of a concept in sequences of states and actions through which the object may proceed during its lifetime as a result of reacting to discrete events dependant on the choices made during concrete implementation of a system from a feature model.

A potential class diagram is a diagram that describes the potential static structure of a system family composed of related concepts. A class diagram is a diagram that describes the static structure of a system composed of related object classes (concept types).

Step 3. Check Out Concept: The developer indicates the desire to modify an existing concept by locking write access to it in the repository. The repository is a version controlled collection of all concept definitions and dependencies for system families.

Step 4. Add Feature: The developer adds a new feature to a concept. If the new feature is metatyped as a state then it may have its own potential statechart for a sub-state machine it may have.

Step 5. Modify Concept or Feature: The developer modifies the name, attributes, metatype or other information associated wit a concept or feature. In the case of a feature this may vary depending on the metatype. A state metatype has an action associated with it, for example. Furthermore, a state may have a signal action which is responsible for sending a signal to a particular service. Modification could also involve changing, adding, or removing the transitions and transition guards on the concept or feature's associated potential statechart.

A service is a process external to a system family with which it communicates. The service is represented within the system family as an interface composed of input and output signals. Output signals can be used to trigger state transitions, while input signals are sent to the service from entry actions.

Step 6. Check In Concept: The developer is finished making changes to the concept and tells the repository about the changes which unlocks the file. All other developers working with the same system family are immediately notified of the new version by the repository.

Step 7. Create or Import Service: The developer creates a new service interface definition or imports one from another system family.

Step 8. Check Out Service: The developer indicates the desire to modify an existing service by locking write access to it in the Repository.

Step 9. Add Signal: The developer adds a new signal to the service interface.

Step 10. Modify Signal: The developer changes the parameters or other information associated with a signal.

Step 11. Check In Service: The developer is finished making changes to the service and tells the repository about the changes (which unlocks the file). All other developers working with the same system family are immediately notified of the new version by the repository.

Step 12. Create System Family Manifest: The developer marks the tip versions of the system family as members of a named manifest version. A manifest is a collection of concepts and services at individual version levels that is tagged and used to describe a single version of a system or system family composed of those concepts and services.

FIG. 16 is a workflow diagram showing how an Integration Developer would use the present invention. An Integration Developer is a developer that uses customer requirements and equipment capabilities to make decisions on optional and alternative features of the concepts in a feature model for a system family to create a specific system meeting those requirements. The Integration Developer may also contact the Feature Developer for additional system family development (i.e. new features). The Integration Developer must first do a requirements investigation by interviewing stakeholders (operations, process engineering, equipment engineering, etc.) to determine the required features for this system deployment by providing a list of automatically supplied features, optional features, and presenting alternative solutions for some features. Also, the Integration Developer must evaluate the semiconductor processing equipment capabilities and requirements by obtaining vendor documentation and testing the equipment. Further, the Integration Developer contacts a Feature Developer to discuss implementation of any new concepts or features. All of this information is used for the process shown in FIG. 16 which describes the sequence of work steps from the Integration Developer's perspective. The steps are outlined below.

Step 1. Choose System Family: The developer chooses a system family within which to develop a system. This involves selecting a particular manifest of the system family for the system to reference. A manifest is a collection of concepts and services at individual version levels that is tagged and used to describe a single version of a system or system family composed of those concepts and services.

Step 2. Create System: The developer creates a new system instance associated with the selected system family.

Step 3. Check Out System: The developer can also check out an existing system for modification.

Step 4. Modify System: The developer modifies the name or other attributes of the system.

Step 5. Use Concept in System: The developer chooses to include a concept from the system family in their system instance. The concept checks its dependencies to determine if it requires other concepts or services to also be included in the system.

Step 6. Choose Optional Feature: The developer chooses whether or not to include an optional feature as part of a concept in their system instance. The concept checks its dependencies as in step 5 above.

Step 7. Choose Alternate Feature: The developer chooses which feature to include in the system instance from among a list of alternatives. The concept checks its dependencies as in step 5 above.

Step 8. Generate System: The developer asks the environment to generate an executable instance of the designed system. The code generator uses the selection information from the system combined with the concept and feature attributes and potential statechart information to generate an implementation of the system with the concrete statechart behavior specified. The template metaprogrmnming library is used to provide base implementations of state machine and object components. The generated code and platform specific executables are provided back to the editor for use by the developer.

Template Metaprogramming use generic programming templates to cause a compiler to execute logic code for the purpose of generating an executable program based on configuration information provided to the compiler.

Step 9. Deploy: The developer deploys the system to equipment controller hardware that is in contact with an equipment.

Step 10. Start Controller: The semiconductor equipment host (controller) is started and integrates the equipment with the automated manufacturing environment.

### Conclusion

The present invention provides methods and systems, which aid in implementing design choices and changes across a family of systems in a more seamless and efficient manner than solutions known in the art. The design choices and changes are accomplished creating feature diagrams or by entering modifications to existing feature diagrams. The feature diagrams are associated with statecharts and as the feature diagrams are modified corresponding changes are made to the associated statecharts. Many of the changes made to the associated statecharts can be performed automatically, reducing the system design process largely to the simple task of modifying feature diagrams. Once all the chosen modifications to the feature diagram(s) have been performed, the resulting, newly-created statechart(s) will be deterministic and can be advantageously utilized to generate computer-executable code. Additionally, the modified feature diagram(s) and resulting deterministic statechart(s) can be later retrieved and modified under the same process to produce new, updated, or modified versions of an implemented system. The generated computer-executable code can be deployed advantageously to help automate manufacturing environments.

What is claimed is:

1. A method for utilizing a feature diagram in the creation of a potential statechart, comprising:
adding a state to the potential statechart for each state-type feature added to the feature diagram;
for each added state-type feature that is an optional feature, adding a decision state to the potential statechart that has a guarded transition to the added state and adding an else transition;
for each alternate relationship to be added to the feature diagram, adding a decision state to the potential statechart and adding a guarded transition from the added decision state to each of the states in the alternate relationship, wherein an else transition is added to the added decision state if the features in the alternate relationship are optional; and
for each or-relationship to be added to the feature diagram, adding a decision state to the potential statechart for each state in the or-relationship, wherein each added decision state has a guarded transition to one of the states in the or-relationship, and each decision state has an else transition.

2. The method of claim 1, wherein the potential statechart conforms to the Unified Modeling Language.

3. The method of claim 1, wherein the feature diagram is useful for modeling a real-time control system.

4. The method of claim 1, wherein the feature diagram is useful for modeling a system for controlling semiconductor equipment.

5. A method for utilizing a feature diagram in the creation of a potential statechart, comprising:
adding a state to the potential statechart for each state-type feature added to the feature diagram;
for each added state-type feature that is an optional feature, adding a decision state to the potential statechart that has one guarded transition to the added state and adding an else transition;
for each alternate relationship to be added to the feature diagram, adding a decision state to the potential statechart and adding a guarded transition from the added decision state to each of the states in the alternate relationship, wherein an else transition is added to the added decision state if the features in the alternate relationship are optional;
for each or-relationship to be added to the feature diagram, adding a decision state to the potential statechart for each state in the or-relationship, wherein each added decision state has a guarded transition to one of the states in the or-relationship, and each decision state has an else transition; and
adding transitions to the potential statechart, wherein the transitions are transitions that are triggered by a signal or stimulus.

6. The method of claim 5, wherein the potential statechart conforms to the Unified Modeling Language.

7. The method of claim 5, wherein the feature diagram is useful for modeling a real-time control system.

8. The method of claim 5, wherein the feature diagram is useful for modeling a system for controlling semiconductor equipment.

9. A method, comprising:
creating a feature diagram and a corresponding potential statechart;
modifying the feature diagram; and
making modifications to the potential statechart that correspond to the modifications of the feature diagram to produce a deterministic statechart.

10. The method of claim 9, wherein the potential statechart conforms to the Unified Modeling Language.

11. The method of claim 9, wherein the deterministic statechart conforms to the Unified Modeling Language.

12. The method of claim 9, wherein the feature diagram is useful for modeling a real-time control system.

13. The method of claim 9, wherein the feature diagram is useful for modeling a system for controlling semiconductor equipment.

14. The method of claim 9, wherein the deterministic statechart is useful for generating computer-executable code.

15. The method of claim 9, wherein the deterministic statechart is useful for generating computer-executable code for a real-time control system.

16. The method of claim 9, wherein the deterministic statechart is useful for generating computer-executable code for a system for controlling semiconductor equipment.

17. A method for generating computer-executable code, comprising:
creating a feature diagram and a corresponding potential statechart;
modifying the feature diagram;
making modifications to the potential statechart that correspond to the modifications of the feature diagram to produce a deterministic statechart; and
generating computer-executable code from the deterministic statechart.

18. The method of claim 17, wherein the potential statechart conforms to the Unified Modeling Language.

19. The method of claim 17, wherein the deterministic statechart conforms to the Unified Modeling Language.

20. The method of claim 17, wherein the feature diagram is useful for modeling a real-time control system.

21. The method of claim 17, wherein the feature diagram is useful for modeling a system for controlling semiconductor equipment.

22. The method of claim 17, wherein the deterministic statechart is useful for generating computer-executable code.

23. The method of claim 17, wherein the deterministic statechart is useful for generating computer-executable code for a real-time control system.

24. The method of claim 17, wherein the deterministic statechart is useful for generating computer-executable code for a system for controlling semiconductor equipment.

25. A system, comprising:
one or more feature diagrams;
one or more deterministic statecharts generated from the one or more feature diagrams; and
computer-executable code generated from the one or more deterministic state diagrams.

26. The system of claim 25, wherein the computer-executable code is useful for implementing a real-time control system.

27. The system of claim 25, wherein the computer-executable code is useful for controlling semiconductor equipment.

28. The system of claim 25, wherein the one or more deterministic statecharts conforms to the Unified Modeling Language.

29. The system of claim 25, wherein the one or more feature diagrams are useful for modeling a real-time control system.

30. The system of claim 25, wherein the feature diagram is useful for modeling a system for controlling semiconductor equipment.

31. A system useful for generating computer-executable code, comprising:
a repository having stored feature diagrams and corresponding potential statecharts; and
an editor capable of making modifications to the stored feature diagrams and capable of making modifications to the potential statecharts that correspond to modifications made to the stored feature diagrams.

32. The system of claim 31, wherein the computer-executable code is useful for implementing a real-time control system.

33. The system of claim 31, wherein the computer-executable code is useful for controlling semiconductor equipment.

34. The system of claim 31, wherein the stored feature diagrams and corresponding potential statecharts are useful for modeling real-time control systems.

35. The system of claim 31, wherein the stored feature diagrams and corresponding potential statecharts are useful for modeling a system for controlling semiconductor equipment.

36. The system of claim 31, wherein the potential statecharts conform to the Unified Modeling Language.

37. A system useful for generating computer-executable code, comprising:
a repository having stored feature diagrams and corresponding potential statecharts;
an editor capable of making modifications to the stored feature diagrams and capable of making modifications to the potential statecharts that correspond to modifications made to the stored feature diagrams; and
a code generator for generating computer-executable code from deterministic statecharts.

38. The system of claim 37, wherein the computer-executable code is useful for implementing a real-time control system.

39. The system of claim 37, wherein the computer-executable code is useful for controlling semiconductor equipment.

40. The system of claim 37, wherein the potential statecharts and deterministic statecharts conform to the Unified Modeling Language.

41. The system of claim 37, wherein the stored feature diagrams are useful for modeling a real-time control system.

42. The system of claim 37, wherein the stored feature diagrams are useful for modeling a system for controlling semiconductor equipment.

43. A machine-accessible medium having associated content capable of directing the machine to perform a method, the method comprising:
creating a feature diagram and a corresponding potential statechart;
modifying the feature diagram; and
making modifications to the potential statechart that correspond to the modifications of the feature diagram to produce a deterministic statechart.

44. A data signal representing computer instructions for causing a computer system to perform a method, the method comprising:
creating a feature diagram and a corresponding potential statechart;
modifying the feature diagram; and
making modifications to the potential statechart that correspond to the modifications of the feature diagram to produce a deterministic statechart.

45. A computer-readable medium having computer instructions for performing a method, the method comprising:
creating a feature diagram and a corresponding potential statechart;
modifying the feature diagram; and
making modifications to the potential statechart that correspond to the modifications of the feature diagram to produce a deterministic statechart.
